(19) United States
(12) Patent Application Publication
(10) Pub. No.: US 2012/0224951 A1
(43) Pub. Date: Sep. 6, 2012

(54) COMPACT FAN ASSEMBLY WITH THRUST BEARING

(75) Inventors: Brett W. DEGNER, Menlo Park, CA (US); Cheng P. Tan, Fremont, CA (US); Con D. Phan, Milpitas, CA (US); Connor R. Duke, Sunnyvale, CA (US); Frank F. Liang, San Jose, CA (US); Jesse T. Dybenko, Cupertino, CA (US); Thomas W. Wilson, JR., Saratoga, CA (US); Keith J. Hendren, San Francisco, CA (US)

(73) Assignee: Apple Inc., Cupertino, CA (US)

(21) Appl. No.: 13/238,488

(22) Filed: Sep. 21, 2011

Related U.S. Application Data
(60) Provisional application No. 61/449,510, filed on Mar. 4, 2011.

(51) Int. Cl. F04D 29/058; B23P 15/00; F04D 29/052

(52) U.S. Cl. 415/174.1; 29/888.025

(57) ABSTRACT

A fan assembly for a computing device is disclosed. The device can include an impeller having a number of blades and a motor for turning the blades. The motor can turn the blades via a magnetic interaction between the impeller and the motor. A thrust bearing can be used to control a position of the impeller relative to the motor. In particular, the impeller can be configured to rotate around an axis and the thrust bearing can be used to control movement of the impeller in a direction aligned with the axis. In one embodiment, the impeller can be configured to generate aerodynamic forces, such as lift, and the parameters associated with the thrust bearing can be selected to counteract the aerodynamic forces so that the impeller remains within a desired positional range relative to the motor.

### CROSS-REFERENCE TO RELATED APPLICATION

This application claims priority to and the benefit under 35 U.S.C. 119(e) of U.S. Provisional Patent Application Ser. No. 61/449,510, filed Mar. 4, 2011, entitled “COMPACT FAN ASSEMBLY WITH THRUST BEARING,” the entire disclosure of which is hereby incorporated by reference.

### BACKGROUND

1. Field of the Described Embodiments

The described embodiments relate generally to computing devices such as desktop computers, laptop computers and the like. More particularly, thermal regulation systems including fans for computing devices are described.

2. Description of the Related Art

Computing devices, such as laptops, include internal components, such as processors, that generate heat. The heat generated by the internal components can cause the internal temperature of the device to rise. Often, to prevent over temperature conditions in the computing device that can damage or shorten its operational lifetime, a thermal regulation system can be included. In some instances, the thermal regulation system can utilize fans to affect the internal airflow within the device and hence the internal temperature distribution.

Modern computing devices, such as laptop devices, can be very compact with a very limited amount space available for packaging the various device components. Thus, minimally sized components that perform their intended function with a maximum amount of efficiency are desired. In view of the foregoing, there is a need for methods and apparatus associated with fan configurations that can be utilized in a compact computing device.

### SUMMARY OF THE DESCRIBED EMBODIMENTS

A highly-efficient and compact fan assembly including a thrust bearing suitable for a laptop computer device is disclosed.

In one embodiment, a portable computing device includes at least a thin-profile enclosure and a thermal regulation system. In one embodiment, the thermal regulation system includes a thin and compact fan assembly disposed with the thin-profile enclosure, the fan assembly including an impeller magnetically coupled to a motor configured to rotate the impeller. The impeller includes a shaft with a thrust plate that allows the impeller to be coupled to a thrust bearing and wherein the thrust bearing is configured to control a position of the impeller relative to the motor such that the magnetic pre-load on the impeller is minimized to increase an efficiency at which rotational velocity is transferred from the motor to the impeller.

In another embodiment, a fan assembly includes at least a housing including an inlet for receiving air and an outlet expelling the air, an impeller including a plurality of blades, mounted within the housing and configured to rotate around an axis. A rotational motion of the impeller causes air to be pulled into the inlet and the air to be pushed out of the outlet and wherein the plurality of blades are shaped such that an aerodynamic force is generated on the impeller in a direction aligned with the axis. The fan assembly also includes a motor for imparting the rotational motion to the impeller wherein the impeller is coupled to the motor via a thrust bearing and wherein the thrust bearing is configured to control a displacement of the impeller in the direction aligned with the axis resulting from the aerodynamic force.

In another embodiment, a centrifugal fan includes a housing with an inlet for receiving air and an outlet expelling the air. An impeller including a plurality of 3-D impeller blades can be mounted within the housing and configured to rotate around an axis. The impeller can include a shaft extending into a center of a motor with a sleeve bearing surrounding the shaft. The motor can impart rotational motion to the impeller via a magnetic interaction between the motor and the impeller where a shape of the 3-D impeller blades, under rotation, generates a lifting force that acts to pull the impeller out of the motor. Thus, an axial control mechanism can be provided for controlling an axial position of the shaft of the impeller relative to the motor. In one embodiment, the axial control mechanism can include a thrust bearing.

In another embodiment a method of manufacturing a fan for cooling a computer enclosure is described. The fan can include an impeller with a shaft that fits within a motor. The method can include 1) determining a maximum thickness of the fan that allows it to fit in the computer enclosure, 2) determining a range of airflow rates for maintaining a temperature in the computer enclosure, 3) determining a length of the shaft that extends into the motor; 4) determining a 3 dimensional shape of impeller blades and a range of rotational velocities that produces the range of airflow rates; 5) determining a lift generated by the 3-D impeller blades as a function of the rotational velocities; 6) determining a size of a thrust plate coupled to the shaft and a fluid surrounding the thrust plate to generate a force that counteracts the lift generated by the 3-D impeller blades; and 7) forming the fan with the range of air flow rates, the determined 3-D shape of the impeller blades, the determined length of the shaft, the determined size of the thrust plate and the determined fluid.

### BRIEF DESCRIPTION OF THE DRAWINGS

The embodiments will be readily understood by the following detailed description in conjunction with the accompanying drawings, wherein like reference numerals designate like structural elements, and in which:

FIG. 1A shows a top view of a fan assembly in accordance with the described embodiments.

FIG. 1B shows a side view of a fan assembly in accordance with the described embodiments.

FIGS. 2A and 2B show top views of impellers in accordance with the described embodiments.

FIGS. 3A and 3B show top views and cross sections of impeller blades in accordance with the described embodiments.

FIGS. 4A-4C show perspective views of impellers in accordance with the described embodiments.

FIG. 5 shows a side view of an impeller and motor including a thrust bearing in accordance with the described embodiments.

FIG. 6A shows a side view of an impeller shaft mounted within a thrust bearing in accordance with the described embodiments.

FIG. 6B illustrates impeller and thrust bearing characteristics as a function of the angular velocity in accordance with the described embodiments.

FIG. 6C illustrates a comparison of performance between impeller designs using 2-D blades with constant cross-section and 3-D blades with varying cross-section.

FIG. 7 is a block diagram of an arrangement of functional modules utilized by a portable electronic device in accordance with the described embodiments.

FIG. 8 is a block diagram of an electronic device suitable for use with the described embodiments.

### DESCRIBED EMBODIMENTS

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

A centrifugal fan assembly is described. The fan assembly can be used as part of a thermal regulation system in a computing device, such as a laptop computer. The fan assembly can be compact and efficient allowing it to be used in a laptop with a relatively thin housing. The fan assembly can include an impeller coupled to a thrust bearing. The thrust bearing can be used to improve the magnetic alignment between the impeller and a motor such that the motor can more efficiently impart rotational energy to the impeller and contact friction between the shaft and the bearing can be reduced as compared to the use of a sleeve bearing. The reduced friction can decrease lubrication requirements and extend the lifetime of the part. In addition, the thrust bearing can be used to minimize axial motions of the impeller potentially reducing vibration and noise.

In one embodiment, the thrust bearing can enable the use of 3-D blade shapes that generate lift. With the sleeve bearing, the lift can pull the impeller out of its bearing and into contact with the fan cover. The thrust bearing can prevent this type of motion and allow 3-D blade shapes that are more aerodynamic efficient to be used such that the overall fan aerodynamic performance is improved. The fan assembly can be disposed within a housing associated with the laptop computer, such as the housing including the main logic board. The laptop computer can include a thermal regulation system that helps to maintain an internal temperature of the laptop within a desired temperature range. The fan assembly can be a component of the thermal regulation system. A logic device within the housing, such as a processor on the main logic board, can be configured to control a rotational velocity of the fan. The rotational velocity of the fan can be adjusted to affect the fan assembly properties, such as an airflow rate through the fan assembly. Based on internal sensor data, such as internal temperature data, the rotational velocity can be selected as a function of time to meet a particular thermal regulation objective, such as a desired thermal cooling effect.

A design objective for the laptop can be to minimize the thickness of the housing. An advantage of using a thrust bearing in the fan assembly is that it allows additional positional control over the rotatable fan components in the fan, such as an impeller, as compared to a sleeve bearing. For instance, the thrust bearing can be configured to control motions of the impeller along the axis of rotation of the impeller. The additional positional control may allow spacing tolerances, such as the spacing tolerance between the impeller blades and the surrounding fan assembly housing to be reduced. The reduced spacing tolerances can allow for a fan assembly enclosure that is thinner and more compact than a fan assembly enclosure that includes an impeller using a sleeve bearing. The thinner and more compact fan assembly enclosure may allow the thickness of the laptop housing to be reduced.

The axial positional control provided by a thrust bearing can have other advantages. With a sleeve bearing, which does not provide axial position control, the impeller in the fan can move up in the axial direction which can create vibrations and generate noise. An advantage of the impeller coupled to a thrust bearing is that the axial motion of the impeller can be controlled to reduce vibrations and associated noise caused by axial motions. Further, the axial motion control provided by the thrust bearing can help to prevent movements that result in undesired contacts between components, such as between the impeller and the fan assembly housing or between the impeller shaft and the thrust bearing. The undesired contact can cause impeller stalling and wear on the fan components including wear on the bearing. As an example, the axial motion control provided by the thrust bearing can prevent part contact resulting from a system shock such as when a laptop including the fan assembly is dropped.

In one embodiment, the impeller can include magnets that are aligned with magnets in a motor to impart a rotational velocity to the impeller. With a sleeve bearing, the magnets in the impeller can be aligned with the magnets in the motor such that a downward magnetic force is generated in the axial direction. The downward magnetic force can provide a pre-load that axially holds the impeller in place. A disadvantage of pre-loading the impeller in this manner is that it causes the motor to less efficiently transfer rotational velocity to the impeller. Further, the magnetic pre-load can press an impeller shaft into a bottom of the sleeve bearing. The magnetic pre-load force of the impeller shaft against the sleeve bearing can generate friction that increases wear on the shaft and the sleeve bearing, increases power requirements and increase lubrication requirements.

With a thrust bearing coupled to the impeller, the motor and the impeller magnets can be aligned such that the magnetic pre-load is essentially eliminated since the thrust bearing provides axial positional control. The better alignment between the motor and impeller magnets allows the impeller to be driven more efficiently by the motor. Further, the elimination of the magnetic pre-load can reduce the friction between the impeller shaft and the bearing. The reduce friction can lessen lubrication requirements and frictional power losses. Thus, the removal of the pre-load can allow the impeller and motor system to operate more efficiently potentially reducing the power required to drive the impeller or allowing the impeller to be driven at a higher velocity for a given power output.

Another advantage of using a thrust bearing is that 2-D or 3-D shaped blades on the impeller can be used. In a 2-D blade, a change in shape of the blades in the axial direction of rotation can be minimal. With a 2-D blade configuration, the forces generated on the impeller in the axial direction are small. With a 3-D shaped blade, the shape of the blade in the axial direction can be varied. The 3-D shape can be selected to meet different objectives, such as to increase the flow rate through the fan or to make the fan more efficient. The 3-D shape can cause aerodynamic forces in the axial direction, such as lift, that can pull an impeller out of its bearing when a sleeve bearing is used. Thus, 3-D shaped blades are typically undesirable for use with sleeve bearings. The axial movement control provided by a thrust bearing can prevent axial motion resulting from aerodynamic forces enabling 3-D blades to be used on the impeller.

In particular embodiments, the fan assembly can include an impeller having a number of blades and a motor for turning the blades. In a particular embodiment, the motor can be configured to generate a rotating magnetic field that can be used to rotate the impeller via magnets installed in the impeller. A thrust bearing can be used to keep the impeller within a desired positional range relative to the motor. The thrust bearing can include a fluid filled reservoir. The impeller can include a shaft including a thrust plate that extends into the fluid filled reservoir. Forces exerted by the fluid in the fluid reservoir on the shaft including the thrust plate can help to control a position of the impeller relative to the motor as well as to the surrounding housing. In one embodiment, the impeller can include a central hub where the shaft, the thrust bearing and the motor can be disposed within a hollow interior portion of the central hub. In another embodiment, the thrust bearing and the motor can be provided as an integrated component. One advantage of a thrust plate is that it can distribute forces, such as a force resulting from a shock to the laptop including the assembly over a wider area. The capability to distribute the force over a wider area may the thrust bearing more shock resistant and hence the fan assembly more robust as compared to using a sleeve bearing alone.

When a shaft for the impeller and the bearing are disposed within a central hub, another advantage of a thrust bearing over is a sleeve bearing is a potential reduction in the shaft length. In a sleeve bearing, since no axial positional control is provided, the impeller shaft typically needs to be longer to insure stability of the impeller as compared to an impeller shaft used with a thrust bearing. A longer impeller shaft can require more lubrication, since the surface area of the shaft is increased, and raise the height of the central hub. As the height of the central hub is raised, aerodynamic performance can be decreased because the central hub can block the airflow into the fan assembly. Further, when the height of the central hub is increased, the overall thickness of the fan assembly can be increased.

The axial positional control afforded by a thrust bearing can allow the impeller shaft to be shortened while maintaining impeller stability. With the impeller shaft shortened, it may be possible to lower the central hub height, which can be used to improve aerodynamic performance of the fan, such as the airflow through the fan. Further, it may be possible to reduce the overall thickness of the fan assembly.

In one embodiment, the fan assembly can be configured as a centrifugal fan. The centrifugal fan can include the impeller mounted within a housing. The impeller can be configured to rotate around an axis such that air is drawn into the housing via an inlet and then expelled from the housing via an outlet. The impeller blades can be shaped to improve airflow through the fan and reduce the noise generated by the fan Impeller blades shaped in this manner can generate aerodynamic forces such as lift. The thrust bearing can be configured to control a displacement of the impeller in a direction aligned with the axis of rotation resulting from aerodynamic forces generated by the blades. In a particular embodiment, the displacement control provided by the thrust bearing may help the magnets in the impeller to remain optimally aligned with the magnets in the motor.

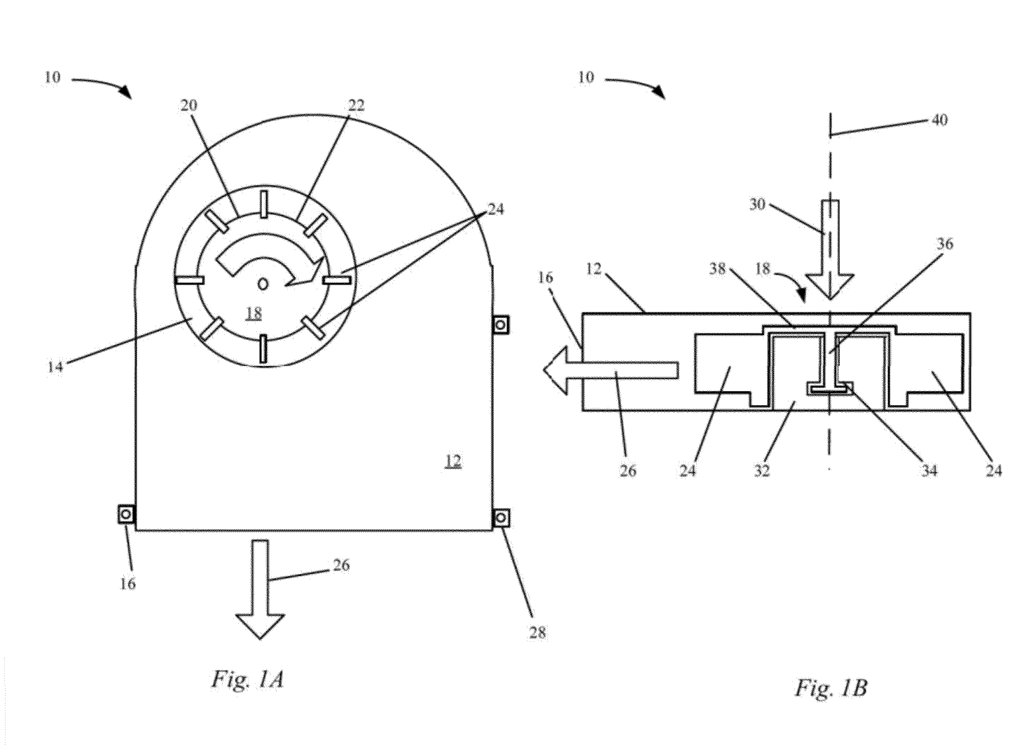

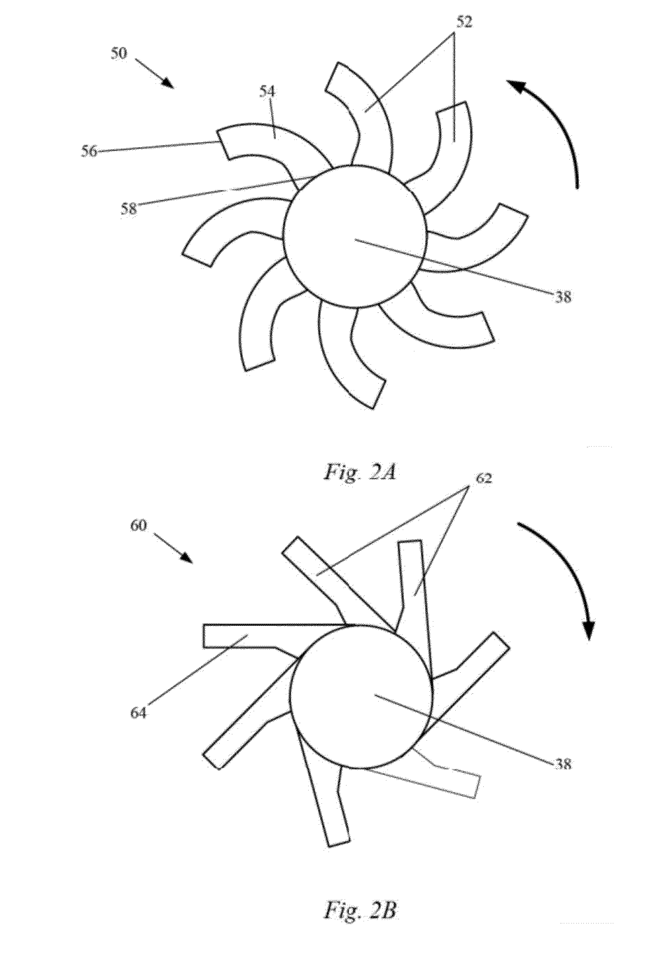

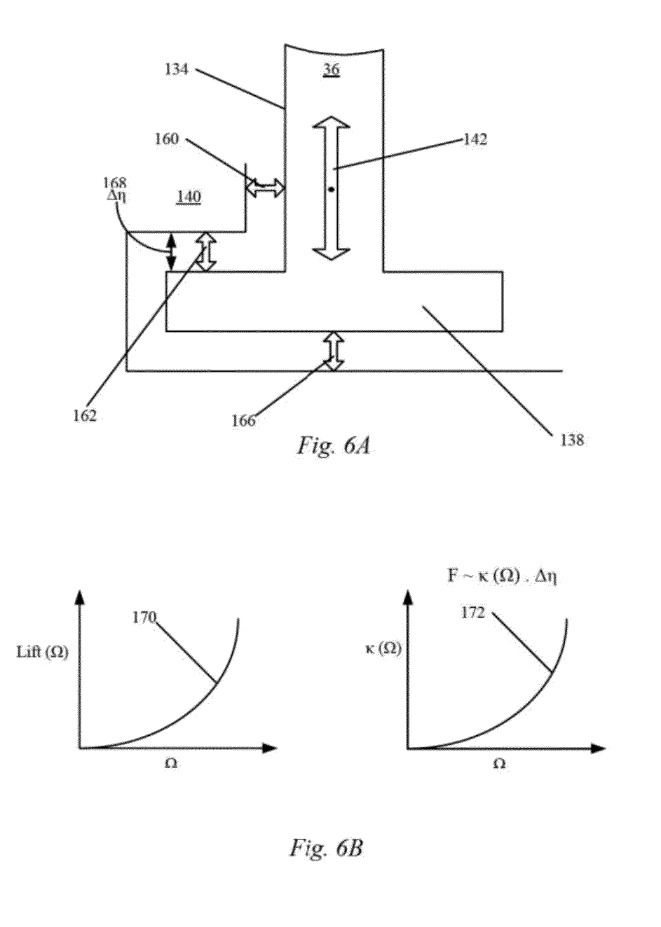

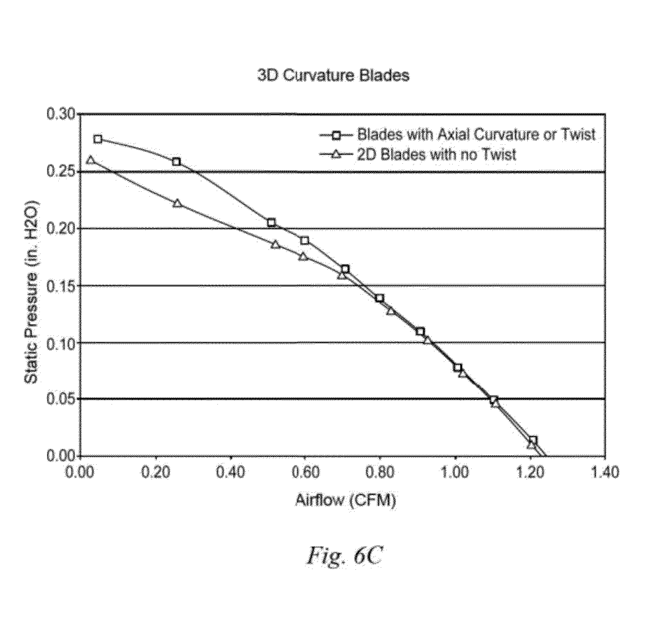

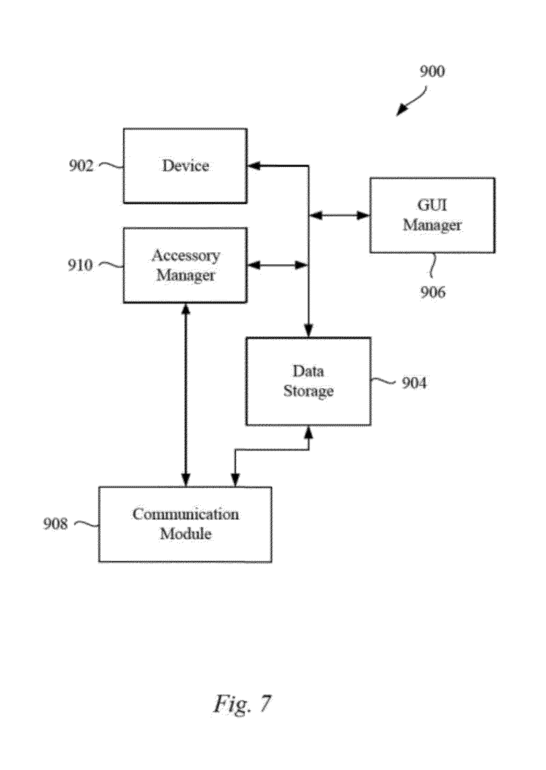

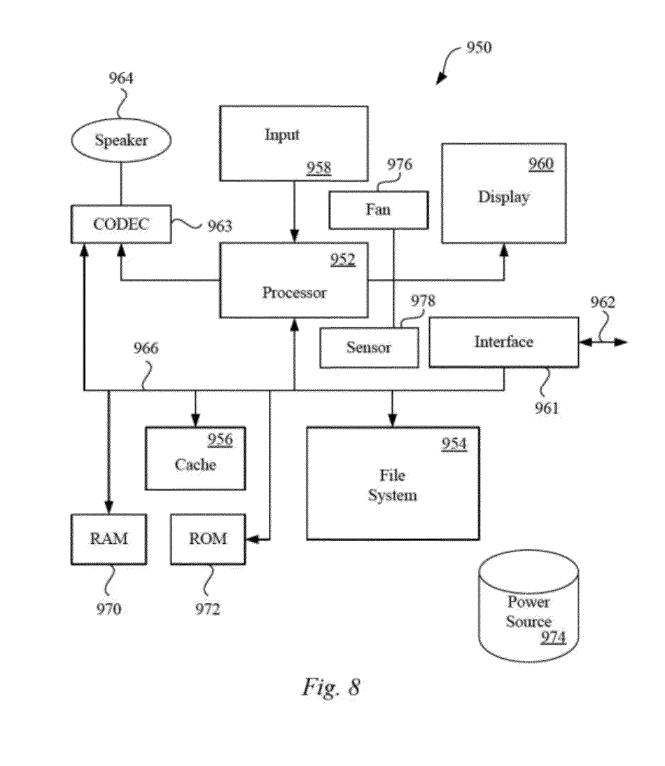

In particular, with respect to FIGS. 1A and 1B, a fan assembly having a housing including an inlet for receiving air and outlet for expelling air is described. The fan assembly can include an impeller coupled to a motor via a thrust bearing. The impeller, motor and the thrust bearing can be disposed within the housing. The impeller can include a plurality of blades. The blades can be shaped to improve airflow and noise characteristics associated with the fan assembly. Blade shapes and impeller configurations are described with respect to FIGS. 2A-4C. With respect to FIGS. 5, 6A and 6B, the thrust bearing interface including the effects of blade shape on the thrust bearing interface are discussed. With respect to FIG. 6C, the effect of blade shape on the fan performance is discussed. In particular, a comparison of performance between 2-D and 3-D blade shapes is shown. Finally, a computing device including the fan assembly is described with respect to FIGS. 7 and 8.

FIGS. 1A and 1B show top and side views of a fan assembly 10. The fan assembly 10 includes a housing 12 with an inlet 14 and an outlet 16. The housing 12 can include a number of attachment points that can allow the fan assembly 10 to be secured. For instance, the fan assembly 10 can be secured within a computing device such as a laptop computer. In one embodiment, the fan assembly 10 can be part of a thermal regulation system associated with the computing device where operation of the fan can help to maintain an internal temperature of the computing device within a desired temperature range.

An impeller 18 with a plurality of blades can be disposed within the housing 12. The fan assembly 10 can be configured such that a rotation of the impeller 18 causes air 30 to be drawn within the housing 10 via the inlet 14. The impeller 18 can impart momentum to the air such that air 26 is expelled out of the outlet 16. The impeller 18 can be configured to rotate about an axis 40 that passes through a point 22 in the center of the impeller. The rotational direction of the impeller 18 is indicated by the arrow 20, which in this example indicates the impeller 18 can rotate in a clockwise direction. In other embodiments, an impeller 18 can be configured to rotate in a counter clockwise direction or in both a clockwise and a counter clockwise direction.

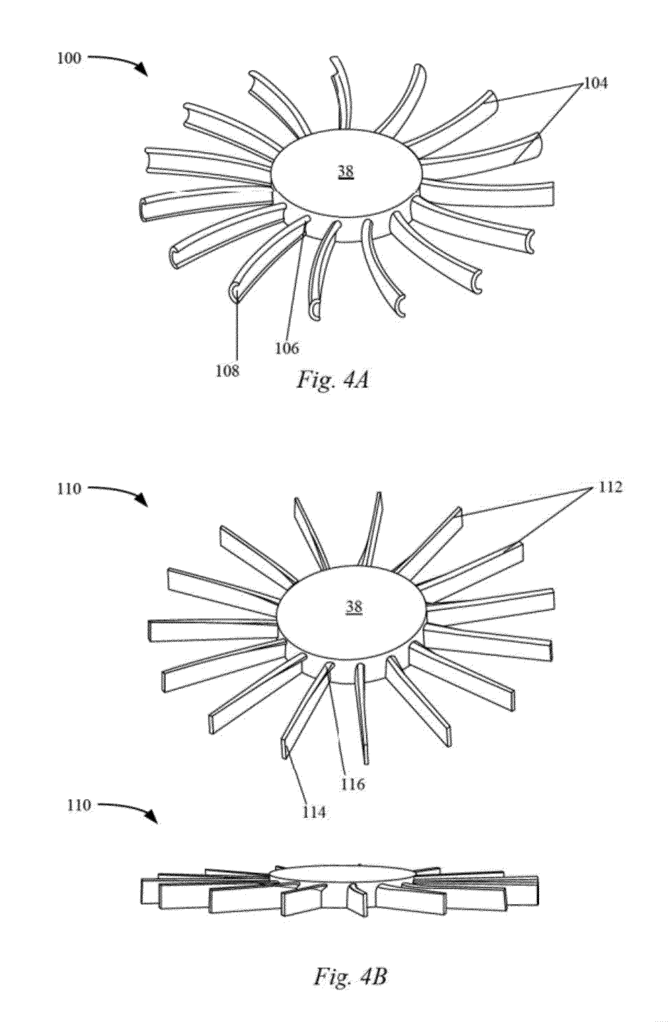

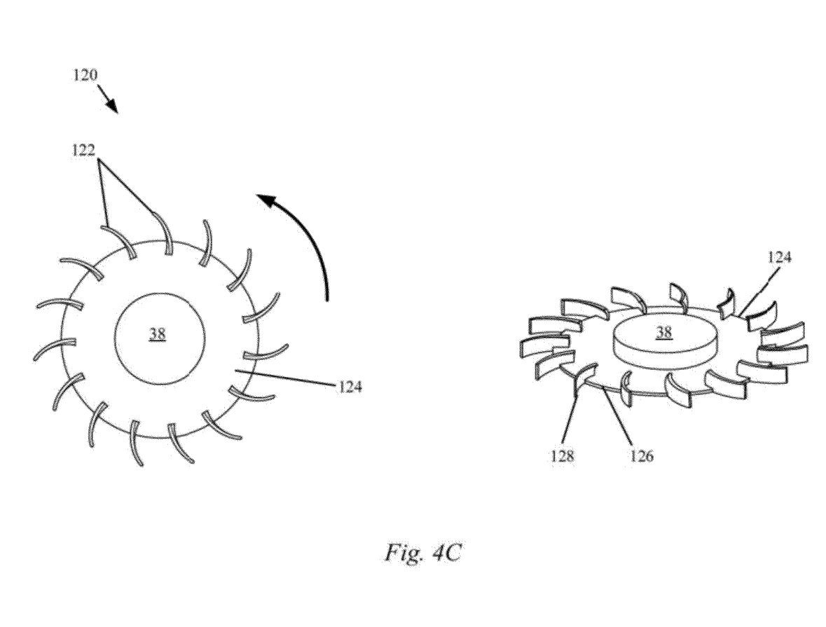

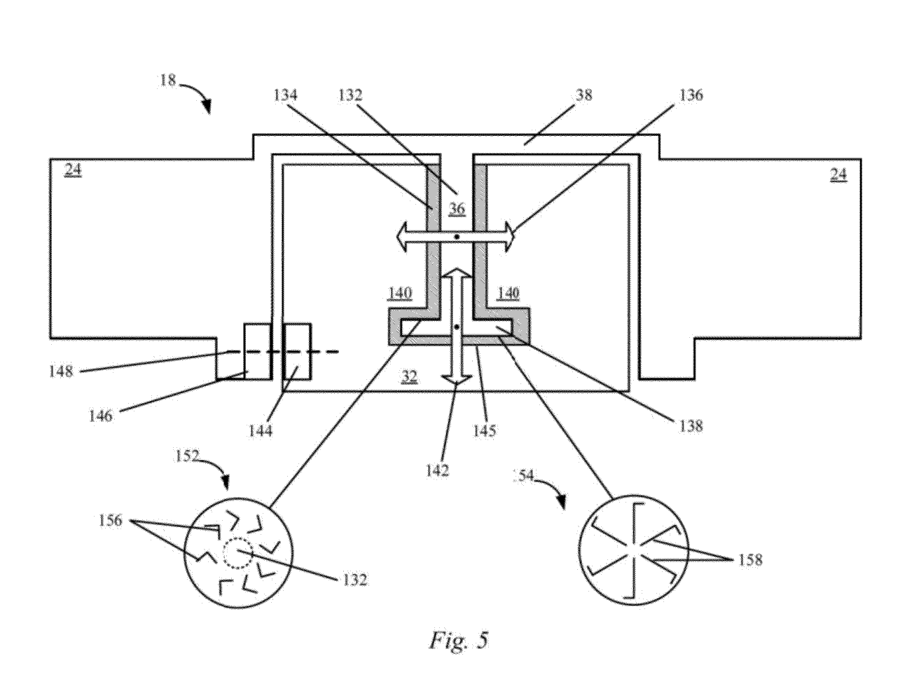

The impeller 18 can include a number of blades, 24. In one embodiment, the blades 24 can be attached to and extend from a hub portion 38 of the impeller 18. In other embodiments, the blades 24 may not be directly attached to the hub (e.g., see FIG. 4C). A shape of the blades 24 and a rotation rate of the impeller 18 can affect the mass flow rate of air passing through the fan assembly and how efficiently the air is moved through the fan assembly 10. As shown, a portion of the blades 24 is visible through the inlet 14. A shape of the blades near the inlet 14, such as a portion of the blades visible through the inlet, can affect how air is drawn into the inlet. Details of blade shape and the effects of blade shape are described in more detail with respect to FIGS. 2A-4C.

A motor 32 can be used to impart a rotational motion to the impeller 18. In one embodiment, a portion of the hub 38 can be hollow to allow all or a portion of a motor to fit within the hub 38. In one embodiment, the motor 32 can be configured to generate a rotating magnetic field that can cause the impeller 18 to rotate via a magnetic interaction between magnets placed in the impeller 18 and the rotating magnetic field generated by the motor 32. A power source can be coupled to the motor 32. The motor 32 can convert the power received from the power source into the rotational magnetic field that is used to drive the impeller 18.

The motor 32 can include a controller (not shown) that allows a rotational rate of the magnetic field generated by the motor and hence a rotational rate of the impeller 18 to be controlled. In one embodiment, the controller can be configured to adjust the rotational rate of the generated magnetic field in response to commands received from a processor associated with a computational device in which the fan assembly is installed. The motor 32 can include one or more sensors that allow a rotational rate of the impeller 18 and/or a status of the motor to be determined. The controller can be configured to communicate information regarding the motor status and the rotational rate of the impeller to the remote processor.

The impeller 18 can include a shaft 36 that extends from the hub 38. The shaft 36 can be coupled to a bearing 34. The bearing 34 can be used to stabilize a position of the impeller 18 relative to the motor 32 during operation of the fan 10. In one embodiment, the bearing 34 can be integrated into the motor 32.

In a particular embodiment, portions of the shaft 36 extending from the hub 38 into the bearing 34 can be of different diameters. For instance, the shaft 36 can include a first portion with a first diameter and a second portion with a second diameter where the second diameter is greater than the first diameter. The second portion with a second diameter can referred to as a thrust plate. In FIG. 1B, the second portion with the second diameter is shown disposed at the end of first portion with the first diameter. In other embodiments, the second portion can be disposed in a with first portion such that the shaft consists of a first portion with a first diameter, a second portion with a second diameter and then a third portion extending from the second portion with the first diameter. Many different types of shaft designs with portions including different diameters are possible and example provided in FIG. 1B is for the purposes of illustration only.

In one embodiment, the bearing 34 can be a thrust bearing and the shaft 36 can be shaped such that it is compatible with the thrust bearing. For instance, as shown, the shaft 36 can include portions with different diameters. The interface between the shaft 36 and thrust bearing can be used to affect a motion of the impeller 18 relative to the thrust bearing including a motion in the direction of axis 40 as well as off-axis motions. As will be described in more detail below (e.g., see FIGS. 5 and 6), control of motion in the direction of axis 40 can be desirable because the blades, such as 24, can be shaped such that an aerodynamic force aligned with axis 40 is generated. For instance, aerodynamic lift can be generated that can cause the impeller 18 to move upwards relative to the thrust bearing 34 and the motor 32.

FIGS. 2A and 2B show top views of impellers 50 and 60. Each impeller can include a number of blades and hub 38. The diameter of the hub 38 can be varied. In addition, the number of blades on each impeller can be varied. For instance, impeller 50 includes 8 blades, such as 52, and impeller 60 includes 6 blades, such as 62. In one embodiment, each blade can be identical and the spacing between each blade can be similar. In other embodiments, on a single impeller, the shape of each blade can vary from blade to blade and the spacing between the blades can be varied. In one embodiment, the spacing between blades can be varied to affect the acoustic properties of the fan.

Each blade can include a root, such as 58, a tip, such as 56, and a planform, such as 54 and 56. The thickness across the planform can vary from the root to the tip. For instance, for blades 52, the planform 54 is thicker at the root 58 than at the tip 56. Further, the planform can vary from blade to blade depending on the impeller design. For instance, blades 54 include a planform that is straighter as compared to the planform for blades 62.

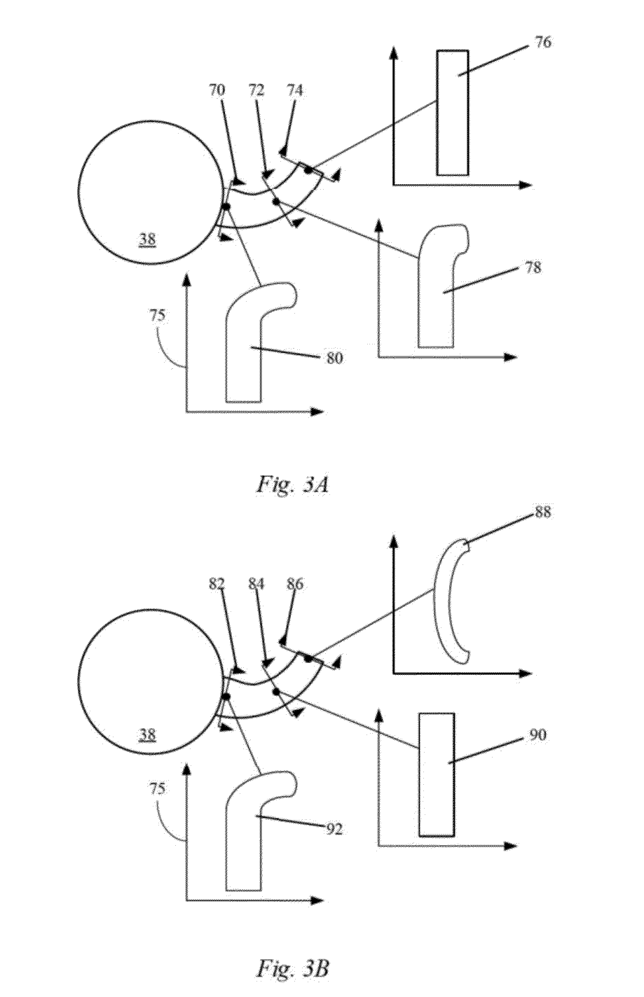

FIGS. 3A and 3B show top views and cross sections of impeller blades. In each figure, a single blade is shown attached to a hub 38. Three cross-sections in the direction of the axis of rotation are shown for each blade. In FIG. 3A, it can be seen that near the root 70, the cross sectional shape 80 is curved near the top and then progresses into a constant cross section shape near the bottom where the cross section is no longer changing in the axial direction 75. In the middle of the blade 72, the cross sectional shape 78 is less curved near the top as compared to the cross sectional shape 80 by the root 70. Near the tip 74, the cross sectional shape 76 does not change in the axial direction and. In particular embodiments, the blades can be shaped such that there is a smooth and continuous transition from cross-section to cross section. In other embodiments, blades can be shaped with discontinuous transitions.

In FIG. 3B, near the root 82 of the blade, the cross section shape 92 is curved near the top and then progresses into a more constant cross sectional shape in the axial direction. Near the middle 84 of the blade, the cross section shape is proximately constant in the axial direction. Near the tip 86 of the blade, the cross sectional is “C” shaped.

The blades can be shaped to affect different performance characteristics of a fan in which they are installed. For instance, a cross sectional shape, such as 80 or 92, can affect the air flow rate of the fan. As another example, a cross section shape, such as 88, can affect an acoustic property of the fan, such as reducing the amount of noise generated by the fan. The amount of noise can be reduced by spreading out the pressure wave that forms at the tip of the blade.

FIGS. 4A-4C show perspective views of impellers in accordance with the described embodiments. In FIG. 4A, an impeller 100 includes a hub 38 and blades 104. The blades 104 are curved near the root 106 such that a “C” shape is formed. The “C” shape is propagated up the length of the blade from the root 106 to the tip 108. At the tip 108, the blades are flat and the “C” shape profile is visible. In FIG. 4B, the blades 112 for impeller 110 are straighter as compared to the blades 104 in FIG. 4A. The blades 112 are curved near the root 116 such that the cross-sectional shape is changing in the axial direction. Near the tip 114 of the blade, the cross sectional shape is substantially constant in the axial direction.

In FIGS. 4A and 4B, the root of each of the blades on the impellers, 100 and 110, are attached to a hub 38. In other embodiments, as shown in FIG. 4C, the blades, such as 122, can be attached to a disk 124 that extends from the hub 38 on impeller 120. In this embodiment, there is a space between the root 126 of the blades 122 and the side of the hub 38. The tip 128 of the blades 122 extends beyond an edge of the disk 124. In other embodiments, the edge of the disk 124 can extend to the tip 128 or beyond the tip 128 of the blades 122.

FIG. 5 shows a side view of an impeller 18 and motor 32 including a thrust bearing interface 140. A shaft 36 can extend from the impeller 18 and into an interior of the thrust bearing 140. The shaft 36 can include a first portion 132 and a second portion 138. In one embodiment, the second portion 138 can be proximately disk shaped with a diameter that is greater than the first portion. The second portion 138 can be referred to as a thrust plate.

During operation of the fan assembly including impeller 18 and motor 32, the shaft 36 can experience side to side forces 136 and/or up and down forces 142. For instance, an upward or downward force can result from an aerodynamic force that is generated by the blades 24 when the impeller rotates. Whether the aerodynamic force is directed upward or downwards can be depend on a shape of the blades 24 and the rotational direction of the impeller 18. The aerodynamic force, as is described in more detail with respect to FIG. 6B can vary according to the rotational speed of the impeller 18. The forces, 136 and 142, can affect a position of the shaft 36 relative to the thrust bearing 140. A side to side force 136 might cause the shaft 36 to move closer to one side of the thrust bearing 140. Whereas, an up or down force 142 might cause the shaft 36 to move closer to a bottom 145 of the thrust bearing 140 or away from the bottom 145 of the thrust bearing 140.

The thrust bearing 140 can include a sealed fluid filled reservoir 134 that surrounds the shaft. During operation, the fluid filled reservoir 134 can exert a force on the shaft 36. In one embodiment, the force exerted on the shaft 36 can be affected by parameters, such as the properties of the fluid in the reservoir, the rotation rate of the shaft 36, a surface geometry of the shaft and/or the cavity of the thrust bearing surrounding the shaft 36 and the distance between each portion of the shaft and the cavity of the thrust bearing. The parameters can be selected such that the forces exerted on the shaft keep the position of the impeller 18 relative to the thrust bearing 140 within some desired range during operation of the fan assembly.

As an example, as described above, the impeller 18 include magnetic components, such as 146, that are configured to interact with magnetic components, such as 144, associated with a motor 32 where the motor via its magnetic components can be used to impart a rotation velocity to the impeller 18. For optimal operation of the motor 32 and the impeller 18 and to prevent collisions between components that can result in undesirable component wear or damage, it may be desirable for the magnetic components to remain relatively aligned with one another. For instance, maintaining the magnetic components 144 and 146 to remain relatively centered with one another around line 148 may improve the efficiency of the system while preventing wear resulting from the impeller 18 colliding with the motor 32 or the housing.

As described above, the surface geometry of the shaft and/or the cavity can affect the forces exerted on the shaft 36 by the fluid within the thrust bearing 140. The surface of the cavity associated with the thrust bearing 140 and/or the surface of the shaft 36 can include channels that affect the forces exerted by fluid on the shaft 36. The channels can be arranged in different geometrical patterns. As an example, a top surface 152 of the thrust plate 138 of the shaft 36 is shown with a first geometrical pattern 156 while a bottom surface 154 of the thrust plate 138 is shown with a second geometrical pattern.

To better illustrate the effects of the geometrical patterns as well as the other parameters describe above on the force exerted by the fluid 134 in the thrust bearing 140, for the purposes of discussion with respect to FIGS. 6A and 6B as follows, the force that the fluid exerts on the shaft 36 can be viewed as a spring where the geometrical patterns have an effect on the spring constant of the spring. In particular, the geometrical patterns can be selected to affect a “stiffness” of the fluid.

FIG. 6A shows a side view of an impeller shaft 36 mounted within a thrust bearing 140. The force exerted by the fluid in the reservoir of the thrust bearing can vary from location to location. For instance, the fluid forces, 160, 162 and 164, are shown at three different locations. The fluid force at each location can depend on parameters such as a spacing 168 between shaft 36 and a side of the bearing cavity at location, the local geometry, such as a local channel pattern (e.g., see FIG. 5), the viscosity of the fluid in the reservoir and the rotation rate of the shaft 36. The fluid force at each location can be modeled as proximately a spring constant, k, times the spacing between the shaft 36 and the thrust bearing cavity at each location.

Using the spring model, the parameters associated with the thrust bearing can be selected to meet particular operation objectives associated with the fan. As an example, as shown in FIG. 6B, the impeller can be configured with blades that generate lift where the lift increases as function of rotational velocity. The lift can cause the impeller shaft to move upwards in the thrust bearing cavity, which is undesirable. To prevent the movement, the local spring constant associated with the force exerted by the fluid, such as the spring constant associated with force 162 can be tuned such that the spring constant increases as the rotational velocity increases as is shown in FIG. 6B. For instance, the local channel geometry on the shaft 36 can be selected to meet this objective. When properly designed, as the rotational velocity increases, the fluid in the thrust bearing can become “stiffer.” The stiffer fluid can prevent the shaft from rising relative to the bearing as a result of the increasing aerodynamic lift generated by the impeller blades.

In one embodiment, the shape of the fluid spring constant curve as a function of rotational velocity can be designed such that it proximately matches the shape of the lift curve associated with the impeller blades. Lift and spring constant curves with this property are shown in FIG. 6B. Further, since the total downward force exerted on the shaft 36 can depend on a size of the thrust plate 138, such as its diameter, the size of the thrust plate 138 of the shaft 36, can be selected such that the disk includes a sufficient surface area to allow the total lift generated by the impeller, which can depend on the size of its blades, to be counteracted by the downward force exerted on the shaft 36 by the fluid in the thrust bearing 140.

FIG. 6C illustrates a comparison of performance between impeller designs using 2-D and 3-D blades in a fan assembly. Performance curves for 2-D blades and 3-D blades are shown. It can be seen that the static pressure head generated for the 3-D blades that include twist is improved for a range of airflows. Thus, the overall efficiency of the fan assembly using the 3-D blades is increased. Typically, in a 3-D blade design, it can be desirable to move the 3-D performance curve up and to the right as compared to the baseline performance curve, such as the 2-D blade design.

In general, the baseline performance curve may be a performance curve for a particular fan design with a particular blade geometry, which can be 2-D or 3-D, a particular impeller geometry, a particular housing geometry and particular power requirements. The particular fan design can be the initial design at the beginning of the design process. A design objective for a new fan design can be to improve some attribute of the initial design while maintaining or improving upon the fan performance over a desired operational range of the fan. For instance, it may be design objective to reduce a height of the fan assembly, the diameter of the impeller or the power used by the fan while maintaining the airflow rate versus pressure performance over some airflow rate range.

During a design process, factors, such as the blade geometry, operational velocity range, impeller geometry, thrust bearing design and fan assembly housing can be adjusted to see if the design objectives are met. As is shown in FIG. 6C, performance curves can be compared for different designs to determine if design objectives have been met. For instance, as is seen in FIG. 6C, the 3-D blade design results in improved performance of the fan assembly over a range of airflows as compared to the 2-D blade design. Other types of performance curves can be used to assess whether a design objective has been met and the example of static pressure versus airflow rate is provided for the purposes of illustration only. For instance, a curve of the power consumption versus airflow rate can be used to assess the fan assembly performance.

For a given design improvement, it may not be necessary to improve or maintain the fan performance over the entire range air flows but over some desired operational range of airflows. Thus, a new design can perform better over or the same as an old design over the desired operational range but more poorly outside of the range. In some embodiments, the operational range for a new fan design can be selected to match some region of peak performance exhibited by the device.

FIG. 7 is a block diagram of an arrangement 900 of functional modules utilized by an electronic device, such as a desktop device or a portable computing device. The arrangement 900 includes a component 902 that is able to output media for a user of the electronic device but also store and retrieve data with respect to data storage 904. The arrangement 900 also includes a graphical user interface (GUI) manager 906. The GUI manager 906 operates to control information being provided to and displayed on a display device. The arrangement 900 also includes a communication module 908 that facilitates communication between the electronic device and an accessory device. Still further, the arrangement 900 includes an accessory manager 910 that operates to authenticate and acquire data from an accessory device that can be coupled to the electronic device.

FIG. 8 is a block diagram of an electronic device 950 suitable for use with the described embodiments. The electronic device 950 illustrates circuitry of a representative media device. The electronic device 950 can include a processor 952 that pertains to a microprocessor or controller for controlling the overall operation of the electronic device 950. The processor 952 and other device components, such as the display 960 or the fan 976, can be configured to receive power from one or more power sources, such as power source 974. In one embodiment, one of the power sources can be a battery.

In particular embodiments, the electronic device 950 can include one or more fans, such as fan 976. The fans can be configured to affect an internal airflow within the electronic device 950. In one embodiment, the fans can be part of a thermal regulation system associated with the electronic device 950. One or more sensors, such as sensor 978, can be used in the thermal regulation system. In one embodiment, a temperature sensor can be used to determine an internal temperature with an enclosure associated with the electronic device 950. The processor 952 can be configured to control the fan 976 in response to the temperature data received from a sensor. For instance, the processor 952 can be configured to turn-on a fan or adjust a speed of the fan, such as a rotational speed of a motor that drives an impeller associated with the fan in response to data received from the temperature sensor.

The electronic device 950 can be configured to store media data pertaining to media items in a file system 954 and a cache 956. The file system 954 can be implemented using a memory device, such as a storage disk, a plurality of disks or solid-state memory, such as flash memory. The file system 954 typically can be configured to provide high capacity storage capability for the electronic device 950. However, to improve the access time to the file system 954, the electronic device 950 can also include a cache 956. As an example, the cache 956 can be a Random-Access Memory (RAM) provided by semiconductor memory. The relative access time to the cache 956, such as a RAM cache, can be substantially shorter than for other memories, such as flash or disk memory. The cache 956 and the file system 954 may be used in combination because the cache 956 may not have the large storage capacity of the file system 954 as well as non-volatile storage capabilities provided by the memory device hosting the file system 954.

The electronic device 950 can also include other types of memory devices. For instance, the electronic device 950 can also include a RAM 970 and a Read-Only Memory (ROM) 972. In particular embodiments, the ROM 972 can store programs, utilities or processes to be executed in a non-volatile manner The RAM 970 can be used to provide volatile data storage, such as for the cache 956.

The electronic device 950 can include one or more user input devices, such as input 958 that allow a user of the electronic device 950 to interact with the electronic device 950. The input devices, such as 958, can take a variety of forms, such as a mouse, a button, a keypad, a dial, a touch screen, audio input interface, video/image capture input interface, input in the form of sensor data, etc. Still further, the electronic device 950 includes a display 960 (screen display) that can be controlled by the processor 952 to display information to the user. A data bus 966 can facilitate data transfer between at least the file system 954, the cache 956, the processor 952, and the CODEC 963.

In one embodiment, the electronic device 950 serves to store a plurality of media items (e g., songs, podcasts, image files and video files, etc.) in the file system 954. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or video content.

When a user desires to have the electronic device play a particular media item, a list of available media items is displayed on the display 960. Then, using the one or more user input devices, such as 958, a user can select one of the available media items. The processor 952, upon receiving a selection of a particular media item, supplies the media data (e.g., audio file) for the particular media item to one or more coder/decoders (CODEC), such as 963. The CODECs, such as 963, can be configured to produce output signals for an output device, such as speaker 964 or display 960. The speaker 964 can be a speaker internal to the media player 950 or external to the electronic device 950. For example, headphones or earphones that connect to the electronic device 950 would be considered an external speaker.

The electronic device 950 can be configured to execute a number of applications besides media playback applications. For instance, the electronic device 950 can be configured execute communication applications, such as voice, text, e-mail or video conferencing applications, gaming applications, web browsing applications as well as many other different types of applications. A user can select one or more applications for execution on the electronic device 950 using the input devices, such as 958.

The electronic device 950 can include an interface 961 that couples to a data link 962. The data link 962 allows the electronic device 950 to couple to a host computer or to accessory devices. The data link 962 can be provided over a wired connection or a wireless connection. In the case of a wireless connection, the interface 961 can include a wireless transceiver.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A portable computing device comprising:
a thin-profile enclosure; and
a thermal regulation system comprising:
a thin and compact fan assembly disposed with the thin-profile enclosure, the fan assembly including an impeller magnetically coupled to a motor configured to rotate the impeller, wherein the impeller includes a shaft with a thrust plate that allows the impeller to be coupled to a thrust bearing and wherein the thrust bearing is configured to control a position of the impeller relative to the motor such that the magnetic pre-load on the impeller is minimized to increase an efficiency at which rotational velocity is transferred from the motor to the impeller.

2. The portable computing device of claim 1, wherein the impeller includes a plurality of 3-D shaped blades wherein the blades are shaped to increase the aerodynamic performance of the fan.

3. The portable computing device of claim 1, wherein the impeller includes a plurality of 3-D shaped blades wherein the blades are shaped to reduce noise produced by the impeller blades.

4. The portable computing device of claim 1, wherein the thrust bearing is configured to control axial motions of the impeller relative to the motor such that noise and vibration generated by the fan assembly.

5. A fan assembly comprising:
a housing including an inlet for receiving air and an outlet expelling the air;
an impeller including a plurality of blades, mounted within the housing and configured to rotate around an axis, wherein a rotational motion of the impeller causes air to be pulled into the inlet and the air to be pushed out of the outlet and wherein the plurality of blades are shaped such that an aerodynamic force is generated on the impeller in a direction aligned with the axis; and
a motor for imparting the rotational motion to the impeller wherein the impeller is coupled to the motor via a thrust bearing and wherein the thrust bearing is configured to control a displacement of the impeller in the direction aligned with the axis resulting from the aerodynamic force.

6. The fan assembly of claim 5, wherein the thrust bearing is integrated into the motor.

7. The fan assembly of claim 5, wherein the impeller includes a shaft having a thrust plate wherein the shaft extends into the thrust bearing such that a portion of the shaft having the thrust plate is surround by a fluid reservoir within the thrust bearing.

8. The fan assembly of claim 7, wherein fluid in the fluid reservoir exerts a force on the thrust plate when the shaft is rotating.

9. The fan assembly of claim 8, wherein the thrust plate includes surface channels that affect the force exerted by the fluid on the shaft.

10. The fan assembly of claim 5, wherein the impeller includes a center hub with a hollow portion and wherein the thrust bearing is disposed within the center hub such that it is at least partially surrounded by the center hub.

11. A centrifugal fan comprising:
a housing including an inlet for receiving air and an outlet expelling the air;
an impeller including a plurality of 3-D impeller blades, mounted within the housing and configured to rotate around an axis, the impeller including a shaft extending into a center of a motor;
a sleeve bearing surrounding the shaft;
the motor for imparting rotational motion to the impeller via a magnetic interaction between the motor and the impeller wherein a shape of the 3-D impeller blades, under rotation, generates a lifting force that acts to pull the impeller out of the motor; and
an axial control mechanism for controlling an axial position of the shaft of the impeller relative to the motor.

12. The centrifugal fan of claim 11, wherein the axial control mechanism comprises:
a thrust plate coupled to the impeller shaft;
a enclosure in the motor surrounding the thrust plate wherein the enclosure forms a fluid filled reservoir surrounding the thrust plate.

13. The centrifugal fan of claim 12 wherein axial control mechanism is configured to generate a larger downward force on the thrust plate as a rotational velocity of the impeller increases to counteract an increase in the lifting force as the rotational velocity of the impeller increases.

14. The centrifugal fan of claim 12 wherein the thrust plate includes channels wherein the channels affect an amount of force exerted on the thrust plate by the fluid surrounding the thrust plate.

15. The centrifugal fan of claim 11 wherein a cross-section shape of the 3-D impeller blades is selected to spread out a pressure wave that forms at a tip of each of the 3-D impeller blades, the pressure wave spread out to reduce aero-acoustic noise generated by the centrifugal fan.

16. The centrifugal fan of claim 11, wherein the shape of the 3-D fan blades is selected to provide an airflow rate through the centrifugal fan such that a computer enclosure in which the centrifugal fan is installed sufficiently cooled.

17. A method of manufacturing a fan for cooling a computer enclosure, the fan including an impeller with a shaft that fits within a motor, the method comprising:
determining a maximum thickness of the fan that allows it to fit in the computer enclosure;
determining a range of airflow rates for maintaining a temperature in the computer enclosure;
determining a length of the shaft that extends into the motor;
determining a 3 dimensional shape of impeller blades and a range of rotational velocities that produces the range of airflow rates;
determining a lift generated by the 3-D impeller blades as a function of the rotational velocities;
determining a size of a thrust plate coupled to the shaft and a fluid surrounding the thrust plate to generate a force that counteracts the lift generated by the 3-D impeller blades; and
forming the fan with the range of air flow rates, the determined 3-D shape of the impeller blades, the determined length of the shaft, the determined size of the thrust plate and the determined fluid.

18. The method of claim 17, further comprising determining an amount of acoustic noise generated by the centrifugal fan and adjusting a shape of the impeller blades to reduce the amount of acoustic noise.

19. The method of claim 17, further comprising determining an amount of vibration generated by the impeller blades and adjusting a shape of the impeller blades to reduce the amount of acoustic noise.

20. The method of claim 17 wherein the motor is configured to drive the impeller via a magnetic interaction and wherein the size of the thrust plate and the fluid are selected to keep the motor and the impeller magnetically aligned such that an amount of magnetic pre-load on the impeller is minimized.

21. The method of claim 17 further comprising determining a groove pattern for the thrust plate wherein the groove pattern affects the force that counteracts the lift generated by the 3-D impeller blades.

22. The method of claim 17 further comprising determining a number of the 3-D impeller blades to attach to a hub of the impeller.

23. The method of claim 22 further comprising determining a diameter and a height of the hub.
